(19) United States
(12) Patent Application Publication
(10) Pub. No.: US 2012/0317281 A1
(43) Pub. Date: Dec. 13, 2012

(54) System and Method for Creating and Tracking Website Visitor Event Sequences

(76) Inventors: Aleksey Fefelov, Ulyanovsk (RU); Gennady Bobrov, Ulyanovsk (RU); Anton Martynov, Ulyanovsk (RU); Denis Martynov, Ulyanovsk (RU); Mikhail Galochkin, Ulyanovsk (RU); Dmitry Kanev, Ulyanovsk (RU)

(21) Appl. No.: 13/492,846

(22) Filed: Jun. 9, 2012

Related U.S. Application Data
(60) Provisional application No. 61/496,056, filed on Jun. 13, 2011.

(51) Int. Cl. G06F 15/173

(52) U.S. Cl. 709/224

(57) ABSTRACT

A method of analyzing user behavior on a website based on the real-time detection of event chains, where each event is a basic action such as a mouseclick, filling in a web form, and so on. The events are linked together into event chains by logical operators.

### CROSS-REFERENCE TO RELATED APPLICATIONS

The present application claims the benefit of U.S. Provisional Patent Application No. 61/496,056, filed Jun. 13, 2011, which is hereby incorporated by reference in its entirety.

### BACKGROUND

Websites exist to enable a visitor to reach a particular goal or goals. The goal depends on the type of website, the target audience, and the type of activity the website is designed for. For example, a visitor to an e-commerce site has the goal of making a purchase; a visitor to an informational site has the goal of learning a particular piece of information; and so on. The website is a tool to enable the visitor to reach their desired goal.

As a website grows, its structure may become more complicated; more pages, more images, more advertising banners, more forms, more videos, etc. These elements can attract visitors and make it easier for them to reach their desired goal, but at the same time, the more complex a website, the harder it is to track its efficiency at enabling the visitors to reach their desired goals, especially since those goals may often be achieved in different ways.

Website owners need to track how successful visitors are at reaching their goals by means of the website, to improve website efficiency and its resulting popularity. Many data mining and web analytics systems exist for that purpose, ranging from very simple to very complex. Some of them, such as U.S. Pat. No. 7,694,311 to Amir et al., set up a “task grammar” that connects events into logical sequences—however, those systems track only URL's that are accessed, rather than other events generated by the visitor, such as mouse-over, mouse-clicks, entering data into forms, and so on. Those events, however, may provide useful clues to why a visitor may be having problems, or what inefficiencies exist in the system. Also, the system described by Amir is very complex, and geared to analyzing weblogs created after the fact rather than analyzing events in real-time. A need therefore exists for a simple, robust system that tracks, not just URL's accessed by the user, but also other events such as the ones described above, and does so in real time.

### SUMMARY OF THE INVENTION

The system and method of the present invention facilitates website performance analysis by allowing the website owner to create sequences, or chains, of visitor events using simple logical connectors and to track these chains in real time as a way to analyze the website's efficiency at enabling a visitor to reach their desired goals. In the preferred embodiment of the present invention, visitor tracking is performed by means of a JavaScript code that is dynamically embedded in the web page during loading. This allows real-time tracking of visitor behavior, which is important for reacting quickly to any problems. Because only a few simple logical connectors are used, the system and method of the present invention is simple and can be cheaply implemented, unlike the more complex systems that track many more variables. However, because it uses logical connectors, the system and method of the present invention is powerful in allowing the website owner to track complex event chains.

A visitor event is a particular action connected to a particular element of the website. For example, a visitor event may be a JavaScript event such as onClick (left mouse-click on the element), onMouseOver (placing the mouse pointer on the element), onFocus (the element gets focus), onBlur (the element loses focus), and so on. The elements of the website may be any objects, both the visual objects (images, links, buttons, forms, etc.) and group objects (tables, layers, webpages).

An event chain is a sequence of visitor events, the full implementation of which by a visitor allows that visitor to achieve their desired goal. The goal can be any desired result achieved by a visitor. For example, a goal may be the successful registration of a user in the system, a successful online purchase, or any other desired result from visiting the website in question.

Since there may be several different chains of events that lead the visitor to the same goal, an analytics tool that allows for logical operators in tracking chains of events is desired. For example, in some cases the exact order of certain events may not matter—what matters is that they all be performed by the visitor. In some other cases, any one of a group of possible events may be performed by the visitor to lead them to the desired goal. In some cases, events may need to be grouped so that logical operators can operate on a group of events.

The preferred embodiment of the system and method of the present invention offers the user the following logical operators:
1. Sequential execution of events (→) is the logical operator that creates a strict order of events in a certain sequence. This allows sequences of events to be tracked when the order of the events is important—for example, a registration process, or working with a “wizard”.
2. Execution of all events (&) is the logical operator that is satisfied when all the events connected by this operator have been performed. The order of execution of these events is not important, and events may be repeated. This can describe processes such as filling out a questionnaire, where all the fields are required but the user may fill them out in any order.
3. Execution of at least one event (||) is the logical operator that is satisfied when at least one of the events connected by the operator has been performed. This allows tracking in a situation where a particular goal can be achieved in several different ways.
4. Grouping ({,}) allows the user to group events and set up logical operators within or between groups of events.

A visual interface can be used to create, store, and modify chains of events. This visual interface consists of functional blocks representing various events that can be dragged and dropped to form sequences. The sequences can then be saved and tracked by the system.

### BRIEF DESCRIPTION OF THE DRAWINGS

FIG. 1 shows the functional block diagram of the system of the present invention.

FIG. 2 shows an example of visitor behavior on a website while making an order.

FIG. 3 shows the logical formula that describes the visitor behavior shown in FIG. 2.

FIG. 4 shows the visual interface of the preferred embodiment of the present invention.

### DETAILED DESCRIPTION OF THE PREFERRED EMBODIMENT

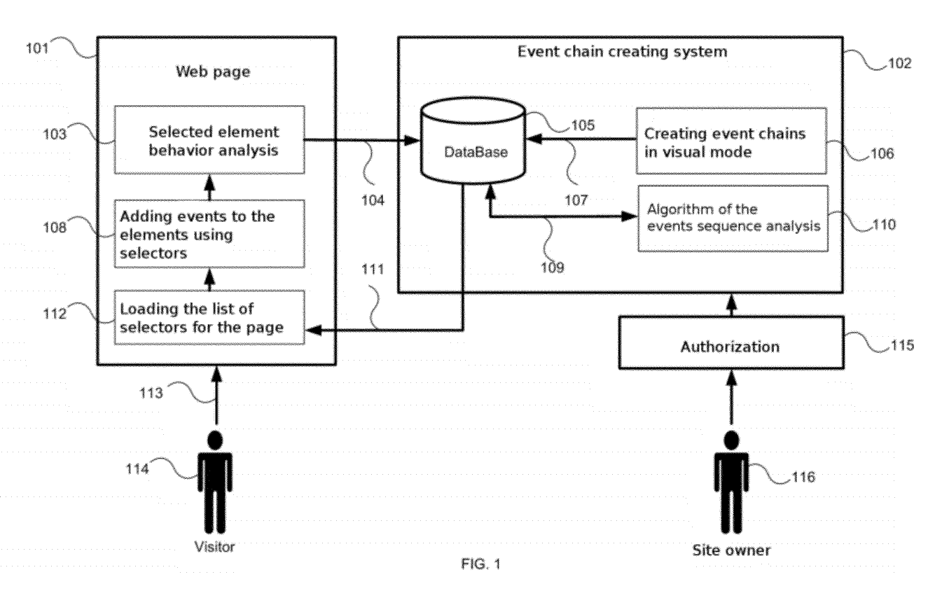

FIG. 1 shows a general functional block diagram of the system of the present invention. Event tracking is performed by means of a JavaScript code that is dynamically embedded in web page 101 of the analyzed website, during its loading 111. The website owner 116 can create particular chains of events to be tracked by means of the event chain creating system 102. Those event chains are then used in the event sequence analysis algorithm 110. The resulting event chains are written into the database 105 as selector descriptions for the elements whose activity needs to be tracked.

When a visitor 114 visits a web page 101, a list of selectors is downloaded from the database 105 for those elements whose activity needs to be tracked. The embedded JavaScript code adds the trackable events to the desired elements 108, and then analyzes the status of those elements 103. When a particular event happens to a certain element, the data about that event 104 is recorded in the database 105. The event sequence analysis algorithm 110 extracts the event information from database 105 and checks whether any of the pre-recorded event chains have been executed. The result of this check is also saved in the database 105.

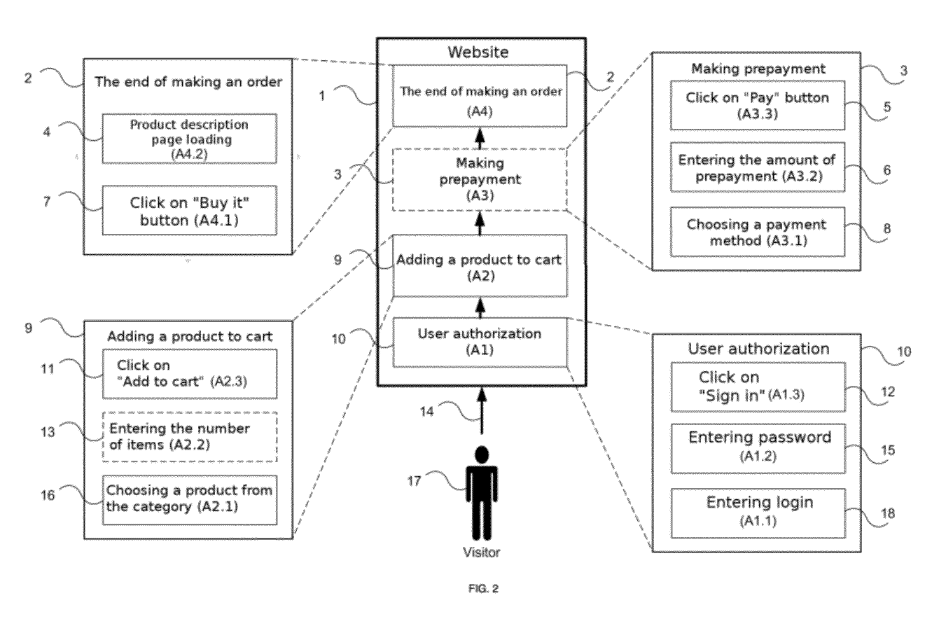

FIG. 2 shows an example of visitor behavior on a website while placing an order. Assume that the procedure for making such an order comprises certain steps 10, 9, 3, 1, and that some steps, such as step 3, are unnecessary. Each of these steps is itself a sequence of simple events that can be aggregated in common blocks. A basic event is an action tracked by JavaScript, such as clicking a button, entering data in a data field, loading a page, etc. In the example shown in FIG. 2, events 4, 5, 6, 7, 8, 11, 12, 13, 15, and 16 are all basic events; each basic event shown in FIG. 2 is marked with its name.

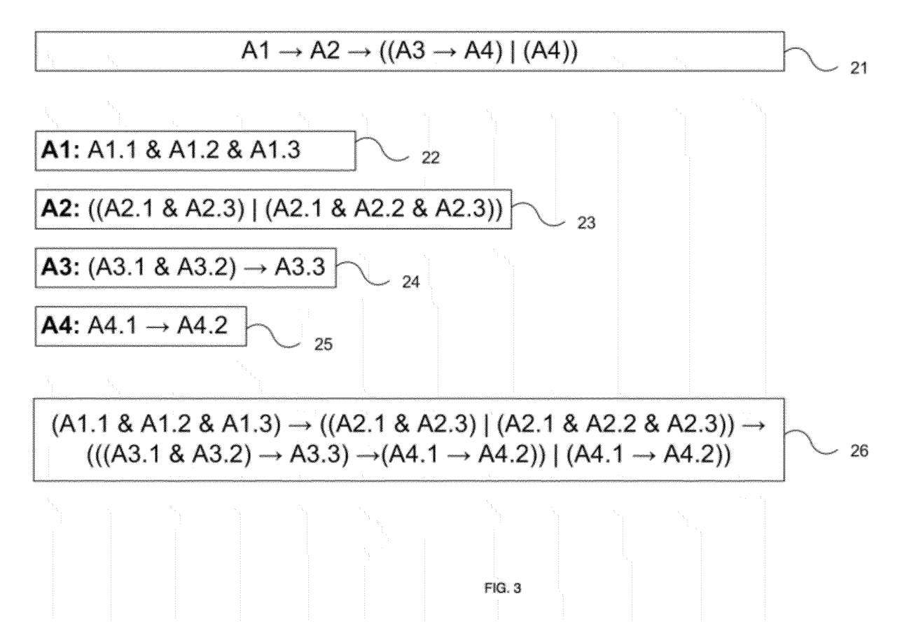

FIG. 3 shows an event chain 21 that describes the process of placing an order shown in FIG. 2. This description is accomplished by means of connecting events with logical operators. Visitor authorization 10 is shown as an event chain 22; adding a product to the shopping cart 9 is shown as event chain 23; the optional prepayment step 3 is shown as event chain 24, and the procedure of making an order 2 is event chain 25.

A more detailed event chain that shows the same information as event chain 21, but is detailed down to the basic event level, is shown as event chain 26.

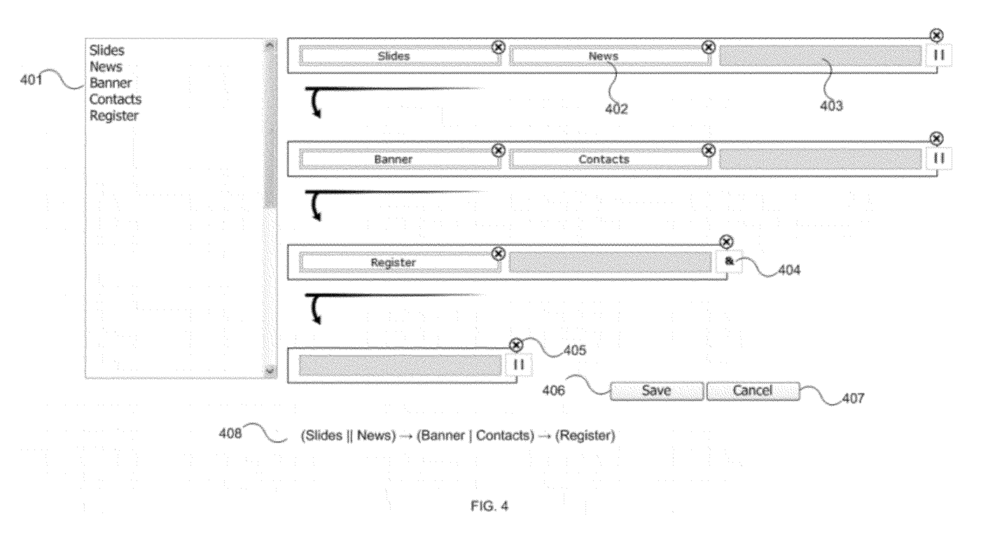

FIG. 4 shows one embodiment of the visual interface that is used to create event chains. This visual interface consists of the below-described functional blocks. The event list 401 shows all the basic events that can be used to create event chains (some sample events are shown, but the embodiment is not limited to the shown sample events). A CSS-based selector creating mechanism (not described in this patent application) is used to create other basic events. Event chains are created by drag-and-drop methods. Each event from the list 401 may be dragged to the free space 403, thereby creating a sequence of basic events that are connected by logical operators 404. Save button 406 and cancel button 407 allow the website owner to save or cancel the creation of the event chain. The event chain 408 is thereby created.

While various preferred embodiments have been described in the above disclosure, there is no intent to limit the invention by it; the above disclosure and the claims are intended to cover all modifications falling within the spirit and scope of the invention, as well as all programming implementations thereof.

1. A method for website analysis, comprising:
a. creating at least one event chain comprising events that can occur during a website visit;
b. recording said event chain in memory;
c. tracking website visitor behavior in real time;
d. identifying when said event chain occurs during the website visitor's visit to the website.

2. The method of claim 1, where the event chain is created by connecting events with logical connectors.

3. The method of claim 2, where the logical connectors comprise an operator that signifies sequential execution of events, an operator that signifies execution of events in any order, an operator that signifies execution of at least one event, and a grouping operator.

4. The method of claim 1, where the tracking website visitor behavior in real time is performed by a script embedded in the web page being visited.

5. The method of claim 1, further comprising:
a. recording the instances when said event chain occurs during the website visitor's visit to the website.

6. The method of claim 1, where the creating at least one event chain is performed using a graphical user interface.

7. The method of claim 1, where the recording of the event chain in memory is performed in a database.

8. A computer system operable to analyze website visitor behavior in real time, said computer system including a processor and a memory device storing instructions that, when executed by the processor, cause the computer system to perform steps comprising:
a. creating at least one event chain comprising events that can occur during a website visit;
b. recording said event chain in memory;
c. tracking website visitor behavior in real time;
d. identifying when said event chain occurs during the website visitor's visit to the website.

9. The computer system of claim 8, where the event chain is created by connecting events with logical connectors.

10. The computer system of claim 9, where the logical connectors comprise an operator that signifies sequential execution of events, an operator that signifies execution of events in any order, an operator that signifies execution of at least one event, and a grouping operator.

11. The computer system of claim 8, where the tracking website visitor behavior in real time is performed by a script embedded in the web page being visited.

12. The computer system of claim 8, further comprising:
a. recording the instances when said event chain occurs during the website visitor's visit to the website.

13. The computer system of claim 8, where the creating at least one event chain is performed using a graphical user interface.

14. The computer system of claim 8, where the recording of the event chain in memory is performed in a database.
